(19) United States
(12) Patent Application Publication
(10) Pub. No.: US 2016/0098976 A1
(43) Pub. Date: Apr. 7, 2016

(54) ADJUSTABLE GUITAR SADDLE

(71) Applicant: Michael Joseph Smith, Clifton, NJ (US)

(72) Inventor: Michael Joseph Smith, Clifton, NJ (US)

(21) Appl. No.: 14/505,220

(22) Filed: Oct. 2, 2014

(51) Int. Cl. G10D 3/04

(52) U.S. Cl. CPC G10D 3/04

(57) ABSTRACT

An adjustable guitar saddle is provided. The adjustable guitar saddle includes saddle piece. Each saddle piece includes a top portion and a bottom portion. At least the bottom portion may be sized to fit within a saddle bridge channel of a guitar. The saddle piece may include at least one bottom threaded aperture running through the bottom portion towards the top portion. At threaded screw may mate with the threaded aperture. The threaded screw rotates and adjusts the height of the adjustable guitar saddle relative to the saddle bridge. The bottom portion of the saddle piece may be placed within the saddle bridge channel and a guitar string may rest on the top portion.

### BACKGROUND OF THE INVENTION

The present invention relates to guitar saddles and, more particularly, to an adjustable guitar saddle.

Most acoustic and acoustic-electric guitars do not enable the player to easily adjust the length and height of the guitar strings for proper pitch and to make the guitar more comfortable to play. Current method of adjustment require modifications to the guitars themselves, such as filing or removing material from the device in order to lower a guitar string. The modifications might alter the tone and value of an instrument and some modifications may be irreversible.

As can be seen, there is a need for a device that adjusts the length and height of guitar strings without altering the guitar.

### SUMMARY OF THE INVENTION

In one aspect of the present invention, an adjustable guitar saddle comprises: a saddle piece comprising a top portion and a bottom portion, wherein the bottom portion is sized to fit within a saddle bridge channel of a guitar and comprises a bottom threaded aperture running through the bottom towards the top, and wherein the top portion is shaped to secure a guitar string; and at least a first threaded screw sized to mate with the bottom threaded aperture and rotatably adjust within, thereby operable to adjust a height of the adjustable guitar saddle relative to the saddle bridge channel.

These and other features, aspects and advantages of the present invention will become better understood with reference to the following drawings, description and claims.

### BRIEF DESCRIPTION OF THE DRAWINGS

FIG. 1 is a detailed perspective view of the present invention shown in use;

FIG. 2 is an exploded view of the present invention;

FIG. 3 is a perspective view of the present invention, in a first position;

FIG. 4 is a perspective view of the present invention, in a second position;

FIG. 5 is a perspective view of the present invention, in a third position;

FIG. 6 is a front view of the present invention;

FIG. 7 is a back view of the present invention;

FIG. 8 is a right side view of the present invention;

FIG. 9 is a profile view of a guitar illustrating the present invention in a first position;

FIG. 10 is a profile view of a guitar illustrating the present invention in a second position; and

FIG. 11 is a profile view of a guitar illustrating the present invention in a third position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a device which allows for individual guitar string adjustment. The present invention provides for easy adjustment of string height (for playing comfort) and string length (for proper pitch along the guitar neck). Further, the present invention may be installed without modification to the instrument, and thereby allows a user to very simply restore the instrument back to its original condition. A screw mechanism allows for easy adjustment of raising or lowering any string, while repositioning of the present invention allows for adjustment of proper string intonation.

The present invention includes a plurality of saddle pieces, with a set screw. Each saddle piece and set-screw may fit under each guitar string. The saddles may occupy the space that was once occupied by the guitar's original one-piece saddle system. The original system may have been one larger piece of material designed to support all of the strings, each individual string would now be supported by one individual saddle and the height-adjustment set-screws. Each string may now be independently raised or lowered, and the intonation of each string may now be adjusted independently by simply repositioning that particular saddle piece.

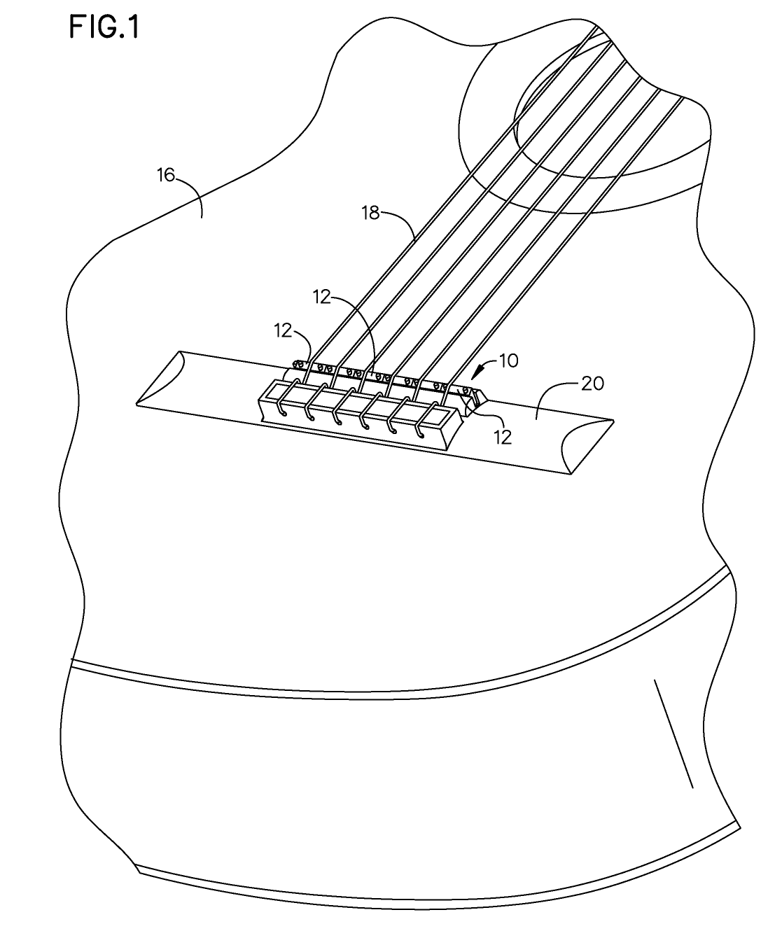

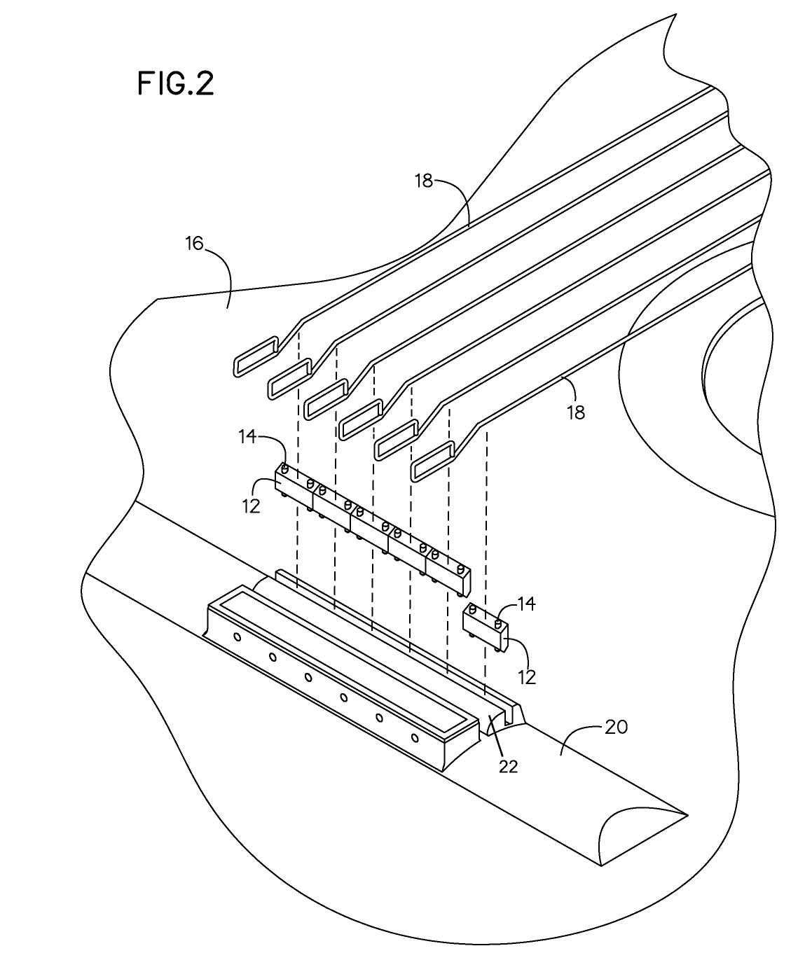

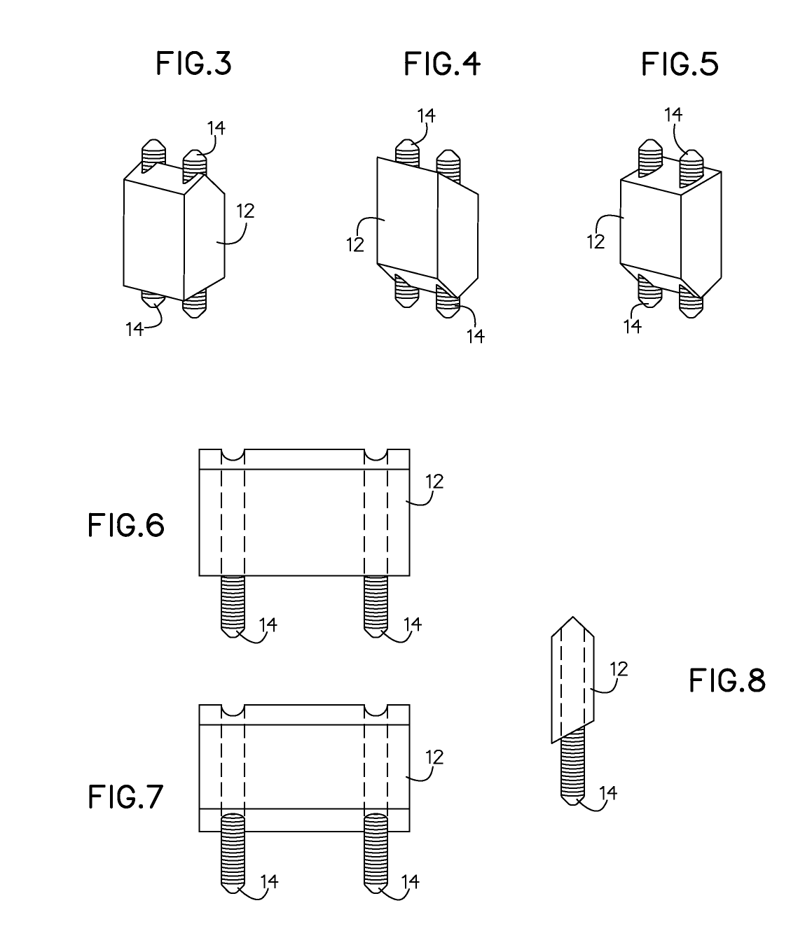

Referring now to FIGS. 1 through 11, the present invention includes an adjustable guitar saddle 10. The adjustable guitar saddle includes saddle pieces 12. Each saddle piece 12 includes a top portion and a bottom portion. At least the bottom portion may be sized to fit within a saddle bridge channel 22 of a guitar 16. The saddle piece 12 may include at least one bottom threaded aperture running through the bottom portion towards the top portion. A threaded screw 14 may mate with the threaded aperture. The threaded screw 14 rotates and adjusts the height of the adjustable guitar saddle 10 relative to the saddle bridge 20 and the guitar 16. The bottom portion of the saddle piece 12 may be placed within the saddle bridge channel 22 and a guitar string 18 may rest on the top portion.

In certain embodiments, the top portion of the saddle piece 12 may fit within the saddle bridge channel 22. Further, the top portion may include a top threaded portion running through the top portion and towards the bottom portion. A second threaded screw 14 may fit within the top threaded portion. Therefore, the saddle piece 12 may be interchangeable between the bottom portion within the saddle bridge channel 22 and the top portion within the saddle bridge channel 22.

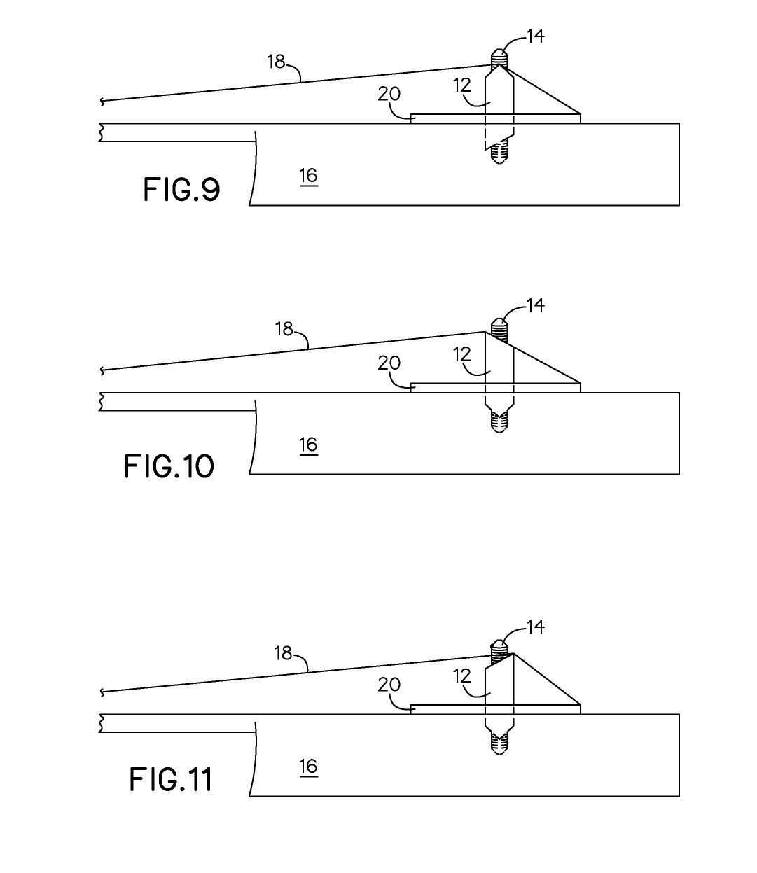

The surface of the top portion and the bottom portion may be flat or rounded. The surfaces may include indentations to center the string on each saddle piece 12. In alternate embodiments, the surfaces may be peaked and angled to allow for more precise intonation of each string 18. As illustrated in FIG. 9 through 11, the top portion surface may include a slant along an entire width from a first side to a second side of the saddle piece 12 and the bottom portion may include a centered point along an entire width from a first side to a second side of the saddle piece 12. Since the top portion and the bottom portions are interchangeable, the saddle pieces 12 may be flipped and rotated to adjust intonation of the string 18.

The present invention may include multiple configurations. For example, each saddle piece 12 may include a pair of top threaded apertures, one on each side and a pair of bottom threaded apertures, one on each side. A first pair of threaded screws 14 may each mate with the pair of top threaded apertures and a second pair of threaded screws 14 may each mate with the pair of bottom threaded apertures. The multiple apertures and screws 14 may add additional balance and support to the present invention.

A method of using the present invention may include the following. The user could incorporate the present invention to alleviate the problem of poor intonation and/or uncomfortable string height on their guitar 16. With the present invention, the user could simply replace the existing one-piece saddle with six of the saddles pieces 12, one per string 18. The user may now have the option/ability to raise or lower each string 18 via the height adjustment screws 14. The option/ability to ‘fine tune’ each strings intonation can now be made by simply repositioning any individual saddle piece 12. The option also now exists for the user to remove these six saddles pieces 12 and return the guitar 16 back to its original condition.

It should be understood, of course, that the foregoing relates to exemplary embodiments of the invention and that modifications may be made without departing from the spirit and scope of the invention as set forth in the following claims.

What is claimed is:

1. An adjustable guitar saddle comprising:
a saddle bridge comprising an elongated channel having a bottom and vertically extending sidewalls, wherein a length of the elongated channel is substantially greater than a width;
a saddle piece comprising a top portion and a bottom portion forming a height, wherein the bottom portion is disposed within the elongated channel so that the height of the saddle piece is vertically disposed relative to the saddle bridge, wherein a bottom threaded aperture runs through the bottom towards the top, and wherein the top portion is shaped to secure a guitar string; and
at least a first threaded screw sized to mate with the bottom threaded aperture and rotatably adjust within, wherein the first threaded screw is adjacent the bottom of the elongated channel and is thereby operable to adjust a height of the saddle piece relative to the saddle bridge channel.

2. The adjustable guitar saddle of claim 1, wherein the top portion comprises a slant along an entire width of the top portion.

3. The adjustable guitar saddle of claim 2, wherein the bottom portion comprises a centered point along an entire width of the bottom portion.

4. The adjustable guitar saddle of claim 3, wherein the top portion is sized to fit within the saddle bridge channel so that the adjustable guitar saddle is interchangeable between the bottom portion within the saddle bridge channel and the top portion within the saddle bridge channel.

5. The adjustable guitar saddle of claim 4, further comprising a second threaded screw, wherein the top portion comprises a top threaded aperture sized to mate with the second threaded screw.

6. The adjustable guitar saddle of claim 4, wherein the saddle piece comprises a pair of top threaded apertures and a pair of bottom threaded apertures.

7. The adjustable guitar saddle of claim 6, further comprising a first pair of threaded screws mating with the pair of top threaded apertures and a second pair of threaded screw mating with the pair of bottom threaded apertures.

8. The adjustable guitar saddle of claim 1, further comprising a plurality of saddle pieces.

9. The adjustable guitar saddle of claim 8, wherein the plurality of saddle pieces is six saddle pieces comprising a single saddle piece for each guitar string.

10. An adjustable guitar saddle comprising:
a saddle piece comprising a top portion and a bottom portion, wherein the top portion and the bottom portion are each sized to fit within a saddle bridge channel of a guitar so that the adjustable guitar saddle is interchangeable between the bottom portion within the saddle bridge channel and the top portion within the saddle bridge channel, wherein the saddle piece comprises a threaded aperture running through the bottom towards the top, and wherein the top portion is shaped to secure a guitar string; and
at least a first threaded screw sized to mate with the bottom threaded aperture and rotatably adjust within, thereby operable to adjust a height of the adjustable guitar saddle relative to the saddle bridge channel.
